(19) United States
(12) Patent Application Publication
(10) Pub. No.: US 2008/0079533 A1
(43) Pub. Date: Apr. 3, 2008

(54) Material of over voltage protection device, over voltage protection device and manufacturing method thereof

(76) Inventors: Te-Pang Liu, Miaoli (TW); Hsiu-Yun Chang, Miaoli (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/651,533

(22) Filed: Jan. 10, 2007

(30) Foreign Application Priority Data
Sep. 28, 2006 (TW) 095136060

(51) Int. Cl. H01C 7/10

(52) U.S. Cl. 338/21

(57) ABSTRACT

The present invention relates to a material of an over voltage protection device and an over voltage protection device manufactured by the material. The material comprises a non-conductive powder, a metal conductive powder, and an adhesive. The over voltage protection device comprises a first electrode, a second electrode, and a porous structure connected between the first electrode and the second electrode. The present invention also relates to a method for manufacturing the over voltage protection device. The present invention also relates to a method of adjusting the breakdown voltage of an over voltage protection device.

### BACKGROUND OF THE INVENTION

1. Field of the Invention

The present invention relates to a material and a structure of an over voltage protection device, and also relates to a method for manufacturing the over voltage protection device.

2. Description of the Prior Art

A common over voltage protection device usually is connected in parallel with a system to be protected, and is grounded in a high-resistance state. When abnormal charges enter the device (i.e., an over voltage is generated), a transient change from high resistance to low resistance occurs, and thus an intruding abnormal energy is conducted to a ground line.

The transient change from high resistance to low resistance is also called a device actuation. The voltage observed then is called a breakdown voltage, which is also referred to as a trigger voltage.

Based on the point discharge principle, charges jumping from one conductor to another and usually the trigger voltage are decreased when the gap between the two conductors is shortened.

A gas tube is a common over voltage protection device, which enables the point discharge of the over voltage energy on an electrode surface and then conducts the over voltage energy to a ground line through a specific gas, which is usually an argon gas, that is, a hollow air chamber is formed between the electrode surface and the ground line. The trigger voltage of the discharge action depends on the gap between the electrode and the ground line. Generally speaking, the shorter the gap is, the easier the discharge is, and the trigger voltage observed at this time is low. If the gap is too large, the electrode does not discharge until sufficient charges are accumulated, so that the trigger voltage observed when the electrode discharges is high. Since the device and the system to be protected are connected in parallel, the trigger voltage at discharge is preferrably low. However, the discharging gap of the gas tube is measured in millimeters (mm) and there is only one discharge position, so the trigger voltage at the time of actuation is quite high. Meanwhile, when the device is actuated, the “sparkles” phenomenon should not appear. Therefore, an electric discharge are must be enclosed in a specific space, and thus the point and the ground line must be enclosed in a container of various shapes, such as a round tube. Furthermore, since the discharge will generate heat, the closed container usually has a large volume for heat dissipation. Therefore, it is difficult to design the device on a chip, and the current requirements for light, thin, short, and small designs cannot be met.

However, unlike other over voltage protection devices, the protection device adopting the point discharge principle has a hollow state between the two electrodes when discharging. The hollow state can be vacuum or gas. The energy is released from the point and enters the ground line through the hollow state, and no matter how many times the protection device is actuated, the problem concerning service life of the material will not occur. With respect to other types of commercialized protection devices such as diodes and ZnO varistors in the market, the major constituents are mostly semiconductors or semiconductor oxides. Since the energy must enter the semiconductors or semiconductor oxides, after multiple actuations, the phenomena of breakdown, reduced resistance, increased leakage current, and short circuits often occur, thereby reducing the service life.

Prior Art 1 (ROC Patent Certificate No. 1253881 of the applicant of the present invention) discloses that an electrode clearance of 5-30 μm is formed between two opposite electrodes by means of precision finishing, i.e., the discharging gap falls in the range of 5-30 μm. The discharge energy is discharged from an electrode at one end to an electrode at the other end through a hollow air chamber. This method is equivalent to the method using the gas tube, but the precise process or control is required when manufacturing, so as to make the electrode clearance between each of the components fall within the designed range. Therefore, this method has constraints on equipment cost and electrode clearance.

Prior Art 2 (ROC Patent Publication No. 475183 of the applicant of the present invention) discloses that a material with a P-N interface is used as a main base matrix. Therefore, the material structure of the manufactured device has a P-N mixed interface. A part of the discharge energy enters the material of the base matrix through the interface. However, not all the materials with the P-N interface can bear the discharge energy, the service life may be short and an additional cost must be incurred to develop this base matrix material.

Basically, the powder material has a P-N interface and is not a “non-conductive” material.

Prior Art 3 (U.S. Pat. No. 6,645,393 of the applicant of the present invention) is similar to Prior Art 2, wherein the material with a P-N interface is replaced by a zinc oxide varistor material. Therefore, this feature has been described above. However, in the practical manufacture of the device, since the melting point of zinc oxide is 1700° C., after a long time and multiple discharge impacts, the zinc oxide material sometimes is broken down and then melts.

Basically, the zinc oxide varistor material has a non-linear resistance and is a variable resistor. Therefore, the zinc oxide varistor material is not the “non-conductive” material described in the present invention, either.

Prior Art 4 (U.S. Pat. No. 5,068,634) discloses a material structure in which conductive powders are dispersed in an insulating binder. The conductive powders fully coat the binder and are spaced apart from one another by the binder. The discharging mechanism controls the interval between the conductors, i.e., the thickness of the binder fully covering the conductor to determine the magnitude of the discharge voltage. The I-V curve obtained according to this method is shown in FIG. 1.

Being identical with the conventional varistor, the discharge energy will pass through the binder between two conductors, so the binder must bear the discharge energy. Therefore, the binder may be burned, and further the two insulating conductors may lose their functions, resulting in a short circuit of the device.

Prior Art 5 (U.S. Pat. No. 4,726,991) discloses a material in which an insulating layer is fully applied on the surface of a conductor or a semiconductor power and the thickness of the insulating layer is controlled to adjust the discharge voltage. The thickness of the insulating layer is smaller than several hundred angstroms. This material structure has some disadvantages in practical application. Firstly, the thickness of the insulating layer is less than several hundred angstroms, so it is quite difficult to control the thickness in the process. When the insulating layer is too thin, a short circuit of the device occurs. When the insulating layer is somewhat thick, the trigger voltage is increased. The above are the disadvantages when the insulating layer is applied on the surface of a conductor or a semiconductor powder.

Prior Art 6 (U.S. Pat. No. 5,294,374) discloses a material structure, which is a mixture of the conductive powder coated with an insulating layer and the semiconductor without a powder coating. The coating thickness is between 70 angstroms to 1 micrometer, wherein the coating material may be a semiconductor. Basically, these materials adopt insulating materials or semiconductor materials to prevent the current from passing through, thereby achieving a high resistance. However, the thickness of the coating layer influences the trigger voltage of the device, so the uniformity of the thickness is quite important.

The techniques of uniformly mixing various conductive powders, semi-conductive powders, or non-conductive powders in a variable resistance material containing a binder have been disclosed in plenty of US patents, such as U.S. Pat. Nos. 3,685,026, 3,685,028, 4,977,357, 5,260,848, 5,393,596, and 5,807,509. The breakdown/trigger characteristics of these materials depend on the constituents of the powders instead of the structure. That is to say, the discharge energy will pass through the interior of the powders. Therefore, the principle is different from the present invention.

### SUMMARY OF THE INVENTION

The present invention is directed to provide a material of an over voltage protection device with a low manufacturing cost and a simple manufacturing process, an over voltage protection device manufactured by using this material, and a manufacturing method thereof.

An embodiment of the present invention provides a material of an over voltage protection device, which comprises a non-conductive powder, a metal conductive powder, and an adhesive.

Another embodiment of the present invention provides a method of manufacturing an over voltage protection device. The method comprises the following steps: uniformly mixing a non-conductive powder, a metal conductive powder, and an adhesive into a paste in a predetermined proportion; printing the paste on a substrate; and performing a firing treatment on the substrate to produce the over voltage protection device.

Still another embodiment of the present invention provides an over voltage protection device, which comprises a first electrode, a second electrode, and a porous structure connected between the first electrode and the second electrode.

The material and structure of the present invention is basically equivalent to a mechanism of the point discharge principle and a gas discharge device, thus having the advantages of a low trigger voltage and a long service life. Furthermore, the material and structure of the present invention can be fabricated as a chip device by using a conventional commercialized process.

The over voltage protection device manufactured according to the present invention can easily achieve an electrode gap less than 5 μm without using precise processing equipment and can provide a large number of discharge positions, thereby greatly reducing over voltages generated when abnormal charges enter a system.

According to the material of the over voltage protection device of the present invention and the fired structure thereof, as the base matrix is a non-conductive material, and does not have the P-N interface or a mixed structure of P powders and N powders, the discharge energy is released only through the discharge positions, and the matrix of the present invention has no interface to be destroyed. Therefore, the device manufactured according to the present invention has a long service life.

### BRIEF DESCRIPTION OF THE DRAWINGS

FIG. 1 is an I-V curve of the material structure disclosed in U.S. Pat. No. 5,068,634;

FIG. 2 is a circuit diagram of a transmission line pulse (TLP) system;

FIG. 3 is an equivalent circuit diagram of the TLP system shown in FIG. 2;

FIG. 4 is a photograph of a compact structure or a structure with few pores generated by sintering a non-conductive material with a high melting point by using the conventional technology;

FIG. 5 is a photograph of a porous structure formed by sintering the material of the over voltage protection device provided by the present invention;

FIG. 6 is an I-V curve of the material and structure of the present invention;

FIG. 7 is a plan view of an over voltage protection device 70 according to an embodiment of the present invention;

FIG. 8 is a side view of the over voltage protection device 70 of FIG. 7;

FIG. 9 is an I-V curve of an embodiment of the present invention;

FIG. 10 is a plan view of an over voltage protection device 100 according to another embodiment of the present invention;

FIG. 11 is a side view of the over voltage protection device 100 of FIG. 10;

FIG. 12 is an I-V curve of another embodiment of the present invention; and

FIG. 13 is an I-V curve of still another embodiment of the present invention.

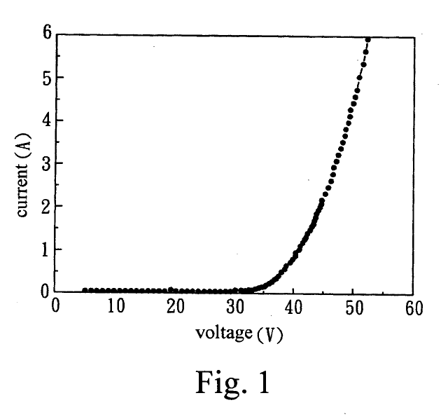

### DETAILED DESCRIPTION

The present invention will be described in detail with reference to the drawings, some of which depict preferred embodiments of the present invention. The present invention is illustrated by several embodiments but not limited to the embodiments.

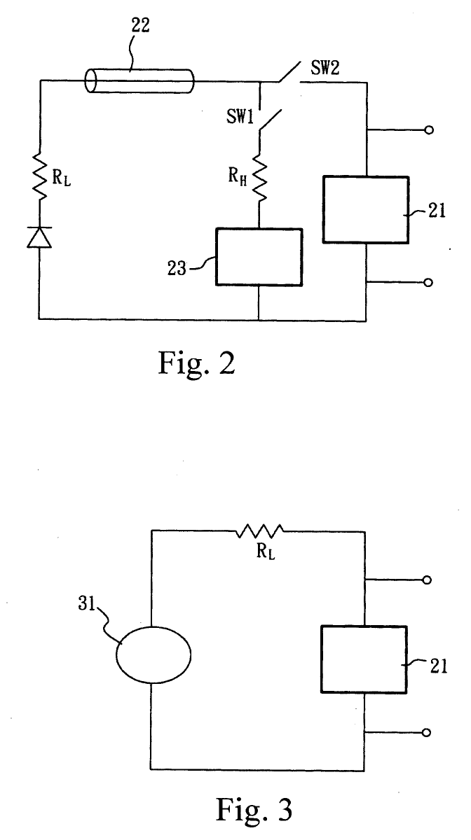

In an electrostatic discharge (ESD) protection circuit, an ESD current is released in a first breakdown area of a device, and the device will not be damaged in the first breakdown area. The first breakdown area has a limit, which is a characteristic of so-called secondary breakdown. When an external overstress voltage or current enters the secondary breakdown area, the device will be damaged permanently. Therefore, the current at the secondary breakdown point represents the upper limit of the capability of the ESD protection device. A transmission line pulse (TLP) system is specially designed to measure the characteristics of the secondary breakdown of the device or an integrated circuit and is a special measuring device that is capable of analyzing the physical characteristics of the device under a high voltage/current test. The TLP system employs the TLP generation principle to provide a single pulse with continuously increasing energy. The principle and the equivalent circuit diagram thereof are shown in FIGS. 2 and 3, respectively. Under the circumstance that a switch SW1 is turned on and a switch SW2 is turned off, a high-voltage generator 23 is used to provide a high voltage to a transmission line 22 via a resistor R_{H}. After that, the switch SW2 is turned on to make a charged transmission line 22 generate a pulse, which is then transmitted to a device under test (DUT) 21, wherein the values of the voltage and current of the DUT 21 are measured via an oscilloscope. FIG. 3 is an equivalent circuit diagram of FIG. 2. A pulse-generating source 31 with a constant pulse width t supplies energy to the DUT 21 through a load resistor R_{L}, and the values of the voltage and current of the DUT 21 are measured via the oscilloscope (not shown).

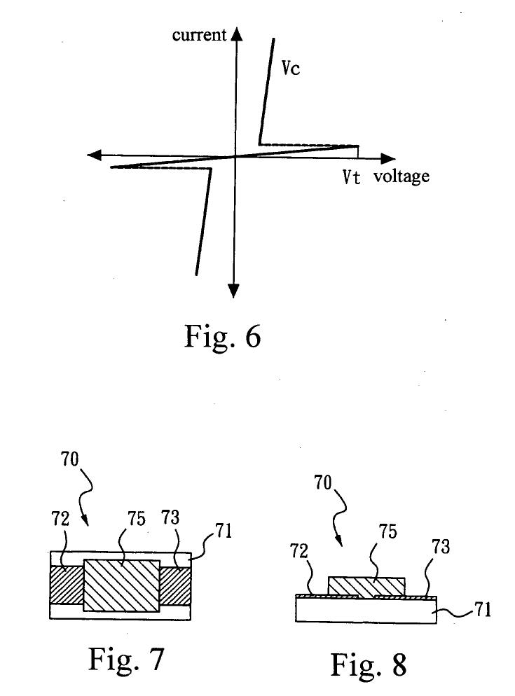

The I-V curves in FIGS. 6, 9, 12, and 13 of the present invention are all measured by using the TLP system shown in FIGS. 2 and 3.

The material of the over voltage protection device provided by the present invention at least includes a non-conductive powder with a particle size in the range of 1-50 μm, a metal conductive powder with a particle size in the range of 0.01-5 μm, and an adhesive. The adhesive is glass and/or polymer resin. If the adhesive is a glass powder, a firing treatment is performed at a temperature of 300-1200° C.; if the adhesive is a polymer resin, the firing treatment is performed at a temperature from a room temperature to 600° C.; and if the adhesive is a mixture of glass powder and polymer resin, the firing treatment is performed at a temperature of 300-600° C. After the aforementioned materials are mixed uniformly, a porous structure with pores of less than 10 μm is formed through the firing treatment. The pores occupy about 5%-90% of the whole volume of the porous structure. The metal conductive powders are uniformly attached to the surface of the non-conductor and distributed in spots. By using a metal conductor in the structure as a conductive medium, the current is continuously bounding by means of point discharge, so as to let the over voltage energy pass through a device having a material structure with micro-clearance discharge points.

Basically, the material and structure of the present invention are obtained by miniaturizing the mechanism of the point discharge principle and a gas discharge device, so as to possess the advantages of a low trigger voltage and a long service life. Furthermore, the material and structure of the present invention may be fabricated as a chip-type device through a conventional commercialized process.

The material of the present invention presents a porous structure after being fired into a product and the metal conductors are uniformly distributed on the surface of the non-conductor. The gaps between the metal conductors are in the range of 0.1-10 μm. The porous structure has stacked pores naturally formed when the non-conductive powders are stacked together. The structural strength, i.e., the adhesion between powders, is not generated by the sintering process, but by using a certain amount of suitable adhesive.

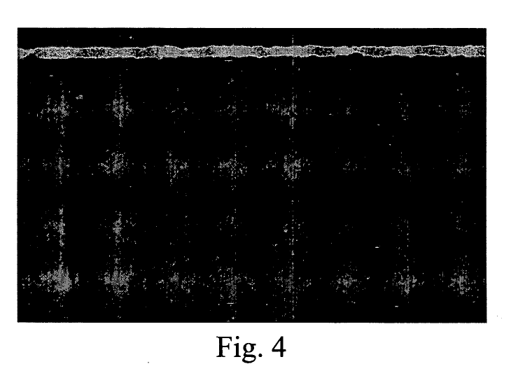

The non-conductor of the material of the present invention may be selected to be an oxide or carbide with a high melting point. In order to sinter the material into a compact structure or a structure with few pores, such as a zinc oxide varistor shown in FIG. 4, the non-conductor with a high melting point is required to be treated by a sintering process at a temperature of over 1200° C., and sometimes a high pressure is further needed, and even a special sintering process. In the present invention, by utilizing the non-conductor's property of being difficult for sintering, a suitable glass is selected to be used as the adhesive between the powders, so as to fabricate a porous structure.

For example, SiC with a decomposition temperature of about 2600° C. is not sintered below 1200° C., a conventional manufacturing temperature for a thick film process or a multilayer process, and particles are bonded and fixed together through an appropriate amount of suitable adhesive, so as to form a porous structure. Through selecting an adhesive with a suitable characteristic and through adjusting the dosage, the adhesive does not fully cover all the surfaces of the matrix and the metal conductor, so that an insulation coating will not formed.

Furthermore, for example, Al₂O₃ with a melting point of 2000° C. is not sintered below 1000° C., a conventional sintering temperature for a thick film process, and particles are bonded and fixed together through an appropriate amount of suitable adhesive, so as to form a porous structure. Through selecting an adhesive with a suitable characteristic and through adjusting the dosage, the adhesive does not fully cover all the surfaces of the matrix and the metal conductor, so that an insulation coating will not formed.

The non-conductive powders of the material of the present invention are high temperature glass powders, for example, glass powders containing over 90% of SiO₂. The glass powders maintain a porous structure below 1200° C., a conventional temperature for a thick film process or a multilayer process.

The metal conductive powders of the material of the present invention include Al, Au, Ni, Cu, Cr, Fe, Zn, Nb, Mo, Ru, Pb, Ir, Ti, Ag, Pd, Pt, or W, or a mixture thereof, or an alloy thereof. The metal conductive powders are uniformly attached to the surface of the porous structure to form “discharge positions,” i.e., positions for the point discharge. The discharge gap, i.e., the distance between each of the “discharge positions,” is determined by the dosage and dispersibility of the metal conductive powders in the material. Since the discharge micro-clearance formed when the material is fired at the temperature of 600-1200° C. is mostly below 10 μm, or even only 1 μm, and there is a huge number of discharge positions in a unit of area, the voltage value required by performing the discharge is greatly reduced.

During the discharge process, when the discharge energy gets close to or contacts the discharge positions on the surface of the base matrix, the discharge occurs and then it is conducted from a source to a “discharge position.” After that, the energy is discharged from the point of the “discharge position” to a next adjacent discharge position, and so forth, till the ground line at the other end is reached.

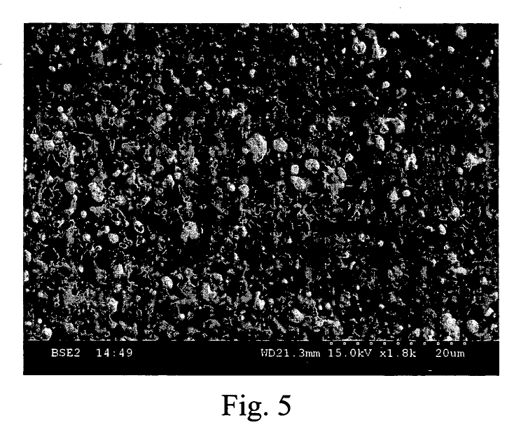

The material and structure of the over voltage protection device of the present invention are shown in FIG. 5, wherein the gray portions are the non-conductor and the glass, the white portions are metal conductors, and the black portions are holes. The material and structure of the present invention follows the I-V curve shown in FIG. 6, wherein Vt in FIG. 6 represents a trigger voltage, and Vc represents a clamping voltage.

The breakdown voltage of the over voltage protection device of the present invention is adjusted through the following methods:

1. Adjust the porosity (i.e., the percentage of the volume of the pore in the whole volume of the porous structure), i.e., adjust the dosage, particle size, and shape of the non-conductive powders.

2. Adjust the dosage or particle size of the metal conductive powders, so as to control and change the distance between the metal conductive powders uniformly attached to the surface of the non-conductor.

3. The contacting situation and extent of the powders are determined by the particle size and shape of the powders, and the area of the powders covered by the adhesive (glass and/or polymer resin), and particularly, for the glass material, it is determined by the glass transition temperature, the high temperature fluidity, and the dosage, and as for the polymer material, it is relevant to the fluidity and dosage.

FIGS. 7 and 8 are a plan view and a side view of an over voltage protection device 70 according to an embodiment of the present invention. In this embodiment, 10 wt % of Ag powders, 50 wt % of Al₂O₃ powders, and 10 wt % of glass powders are compounded with 30 wt % of ethyl cellulose resin solution by using a 3-roll mill, so as to form a paste 75 for printing.

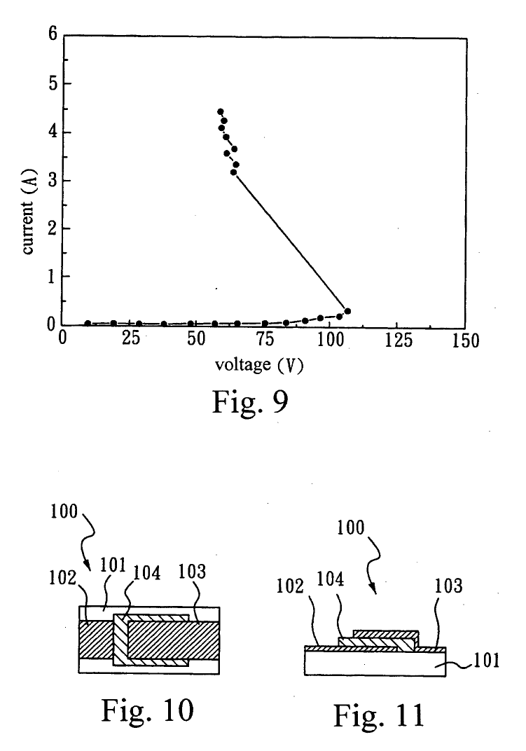

Firstly, a first electrode 72 and a second electrode 73 are formed on an Al₂O₃ substrate 71, and then, a paste 75 is applied on a part of the first electrode 72 and the second electrode 73 close to gap 74. After the firing treatment at 850° C., the material 75 of the present invention is attached to the Al₂O₃ substrate 71, the first electrode 72, and the second electrode 73. The first electrode 72 is connected to the circuit of a system, and the second electrode 73 is connected to a ground line, so that the device 70 is connected with the system (not shown) in parallel. When an abnormal energy enters the system, it is conducted to the material 75 via the first electrode 72, and then, discharged through micro-gaps within the material 75. Then, the over voltage energy is transmitted to the second electrode 73 and then to the ground line. The I-V curve in this embodiment is shown in FIG. 9.

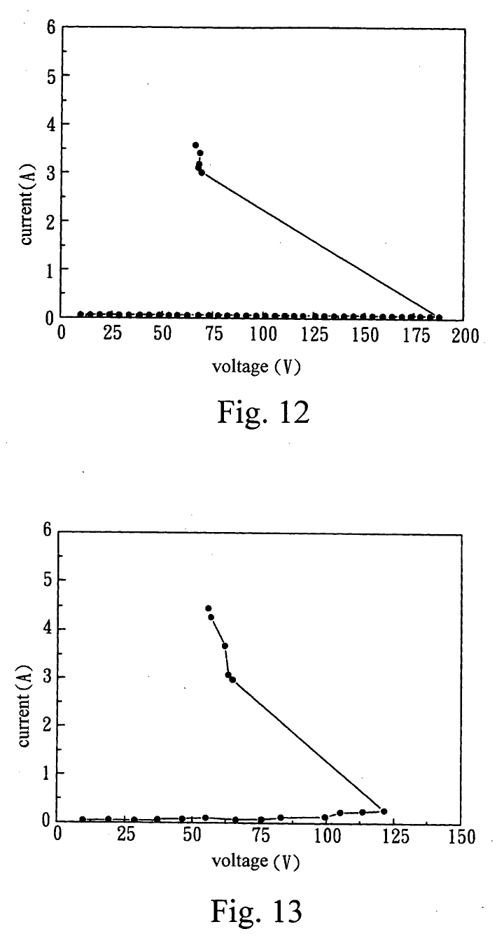

FIGS. 10 and 11 are a plan view and a side view of an over voltage protection device 100 according to another embodiment of the present invention. In this embodiment, ingredients of a paste 104 are the same as that of the paste 75 in the first embodiment. Firstly, a first electrode 102 is formed on an Al₂O₃ substrate 101. Then, the paste 104 of the present invention is printed on the first electrode 102, wherein a part of the paste 104 is printed on the first electrode 102, and the rest is printed on the Al₂O₃ substrate 101. Finally, a second electrode 103 is formed, wherein a part of the second electrode 103 is attached to the paste 104 and the rest is attached to the Al₂O₃ substrate 101. After the firing treatment at 850° C., the material 104 of the present invention is attached to the Al₂O₃ substrate 101 and the first electrode 102, and the second electrode 103 is attached to the material 104 and the Al₂O₃ substrate 101. The first electrode 102 is connected to a system (not shown), and the second electrode 103 is connected to the ground line, so that the device 100 is connected to the system in parallel. When an abnormal energy enters the system, it is conducted to the material 104 via the first electrode 102, and discharged through micro-gaps within the material 104. Then, the over voltage energy is transmitted to the second electrode 103 and then to the ground line. The I-V curve in this embodiment is shown in FIG. 12.

In another embodiment of the present invention, 15 wt % of Pt powders, 45 wt % of Al₂O₃ powders, and 15 wt % of glass powders are mixed with 25 wt % of ethyl cellulose resin solution by using a 3-roll mill, so as to form a paste for printing, and then, a structure that is the same as that in the second embodiment is fabricated. The I-V curve in this embodiment is shown in FIG. 13.

The features and technical contents of the present invention have been disclosed above and those skilled in the art may make variations or modifications according to the disclosure and teachings of the present invention without departing from the spirit of the present invention. Therefore, the scope of the present invention to be protected should cover not only the aforementioned embodiments, but also the variations and modifications.

What is claimed is:

1. A material of an over voltage protection device, comprising:
a non-conductive powder;
a metal conductive power; and
an adhesive.

2. The material of an over voltage protection device as claimed in claim 1, wherein the non-conductive powder has a particle size between 1 μm and 50 μm.

3. The material of an over voltage protection device as claimed in claim 1, wherein the metal conductive powder has a particle size between 0.01 μm and 5 μm.

4. The material of an over voltage protection device as claimed in claim 1, wherein the adhesive comprises a glass powder.

5. The material of an over voltage protection device as claimed in claim 1, wherein the adhesive comprises a polymer resin solution.

6. The material of an over voltage protection device as claimed in claim 1, wherein the adhesive comprises a glass powder and a polymer resin solution.

7. The material of an over voltage protection device as claimed in claim 1, wherein the non-conductor is a carbide with a high melting point.

8. The material of an over voltage protection device as claimed in claim 7, wherein the carbide with a high melting point is SiC.

9. The material of an over voltage protection device as claimed in claim 1, wherein the non-conductive powder is an oxide with a high melting point.

10. The material of an over voltage protection device as claimed in claim 9, wherein the oxide with a high melting point is Al₂O₃.

11. The material of an over voltage protection device as claimed in claim 1, wherein the non-conductive powder is a high-temperature glass powder.

12. The material of an over voltage protection device as claimed in claim 11, wherein the high-temperature glass powder is a glass powder containing more than 90% SiO₂.

13. The material of an over voltage protection device as claimed in claim 1, wherein the metal conductive powder is selected from a group consisting of Al, Au, Ni, Cu, Cr, Fe, Zn, Nb, Mo, Ru, Pb, Ir, Ti, Ag, Pd, Pt, or W, a mixture thereof, or an alloy thereof.

14. A method of manufacturing an over voltage protection device, comprising:
uniformly mixing a non-conductive powder, a metal conductive powder, and an adhesive into a paste in a predetermined proportion;
printing the paste on a substrate; and
performing a firing treatment on the substrate to produce the over voltage protection device.

15. The method as claimed in claim 14, wherein the step of printing the paste on the substrate comprises:
forming a first electrode and a second electrode on the substrate; and
printing the paste on the substrate, wherein the paste partially overlaps the first electrode and the second electrode.

16. The method as claimed in claim 14, wherein the step of printing the paste on the substrate comprises:
forming a first electrode on the substrate;
printing the paste on the substrate, wherein the paste partially overlaps the first electrode; and
forming a second electrode on the substrate, wherein the second electrode partially overlaps the paste.

17. The method as claimed in claim 14, wherein if the adhesive is a glass powder, the firing treatment thereof is performed at a temperature of 300-1200° C.

18. The method as claimed in claim 14, wherein if the adhesive is a polymer resin solution, the firing treatment thereof is performed at a room temperature to 600° C.

19. The method as claimed in claim 14, wherein if the adhesive is a glass powder or a polymer resin solution, the firing treatment thereof is performed at a temperature of 300-600° C.

20. An over voltage protection device, comprising:
a first electrode;
a second electrode; and
a porous structure, connected between the first electrode and the second electrode, wherein the porous structure is produced by performing a firing treatment on the material of the over voltage protection device as claimed in any one of claims 1-13.

21. The over voltage protection device as claimed in claim 20, wherein the pore of the porous structure is below 10 μm.

22. The over voltage protection device as claimed in claim 20, wherein pores of the porous structure occupy 5%-90% of the volume of the porous structure.

23. The over voltage protection device as claimed in claim 20, further comprising a substrate, wherein the first electrode and the second electrode are both attached to the substrate and spaced by a gap and the porous structure is deposited on a part of the first electrode and a part of the second electrode and in the gap.

24. The over voltage protection device as claimed in claim 20, further comprising a substrate, wherein the first electrode is deposited on the substrate, the porous structure is deposited on the substrate and the first electrode, and the second electrode is deposited on the substrate and the porous structure.
